(19) United States
(12) Patent Application Publication
(10) Pub. No.: US 2010/0077396 A1
(43) Pub. Date: Mar. 25, 2010

(54) PORTABLE STORAGE DEVICE FOR SUPPORTING PORTABLE COMPUTING SYSTEM AND PORTABLE COMPUTING BASED SYSTEM USING THE SAME

(76) Inventors: Ji Hoon Choi, Daejeon (KR); Ki-Hyuk Nam, Daejeon (KR); Won-Young Kim, Daejeon (KR); Wan Choi, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/516,591

(22) PCT Filed: Nov. 26, 2007
(86) PCT No.: PCT/KR07/05982

§ 371 Date: May 28, 2009

(30) Foreign Application Priority Data
Dec. 4, 2006 (KR) 10-2006-0121538
Sep. 28, 2007 (KR) 10-2007-0098054

(51) Int. Cl. G06F 9/455; G06F 12/14

(52) U.S. Cl. 718/1; 711/163; 711/E12.001; 711/E12.093

(57) ABSTRACT

Provided are a portable computing system that allows computing operations anywhere an operating system (OS)-installed host computer exists by using a portable storage device storing a virtual machine, an OS image, a portable software image, etc. and a portable computing based system using the portable computing system. The portable storage device for supporting a portable computing system includes: a portable computing system storage storing portable software for running and operating of a portable computing system, wherein a user may not directly access the portable software for deletion and modification; a portable software storage storing portable software images usable in the portable computing system, wherein a user may not directly access the portable software images for deletion and modification; and a portable data storage capable of adding, deleting, and modifying data.

### TECHNICAL FIELD

The present invention relates to a portable computing system complementing software distribution and management functions, and more particularly, to a portable computing system that allows computing operations anywhere an operating system (OS)-installed host computer exists by using a portable storage device storing a virtual machine, an OS image, a portable software image, etc. and a portable computing based system using the portable computing system.

This present invention is a result of an IT new growth power core technology development project (an IT R&D project), supported by ministry of information and communication and institute for information technology advancement [project management number: 2005-S-007-022, project name: open SW based on-demand office environment technology development].

### BACKGROUND ART

Lately, computers equipped with USB (universal serial bus) interfaces are extensively used, and storage capacities of portable storage devices supporting USB interfaces increase from tens to hundreds GB. Additionally, storage capacities of a CF card and a memory stick increases to hundreds GB.

Furthermore, according to the USB interface, because most computers support USB 2.0, data transfer speed drastically increases compared to USB 1.0. Regardless of this advantage, the portable storage device is merely used as an auxiliary storage device for storing data.

A portable personal computing environment by IBM evolves the portable storage device into not the simple storage device but a portable personal computing environment system, which is available anyplace with a computer.

That is, a host computer, which is bootable through the portable storage device, is booted with a host OS after storing a host OS, a virtual machine, and various guest OS in the portable storage device. Then, the host computer runs various guest OS in a virtual machine window for various applications capable of operating in a corresponding OS.

On the other hand, a virtual or software appliance technology is one form of software distribution and management. Software appliance includes software and the minimum system software (OS, a file system, an application server, etc.) necessary for operating the software, and is distributed to customers through a CD, an USB portable storage device, and a remote server.

These software appliances are provided through a subscription service in order to minimize a user's burden for additional installation, setting, and management of software. The virtual appliance in one type of the software appliances distributes software in a format that is capable of operating in a specific virtual machine. That is, if a virtual machine supporting a corresponding format is installed, the virtual appliance may run in any host computer.

The virtual appliance or the software appliance is used for distribution and management of a specific software, and is mainly focused on minimizing and running additional components besides software to be distributed (e.g., a virtual machine or a system software). Additionally, the portable storage device may not be used as medium for distributing and managing software.

However, the virtual appliance or the software appliance is very similar to the form of the portable personal computing environment by IBM. Accordingly, software distribution and management functions are complemented in a portable personal computing environment, which is similar to a conventional desktop environment.

In software distribution technology, client/server-based software streaming technology may be utilized for a portable storage device. This technology does not install an application program package stored in a portable storage device into a host computer, and may run an application program after creating a virtual environment as if the application program is installed in the host computer.

### DISCLOSURE OF INVENTION

### Technical Problem

Accordingly, the present invention is directed to a portable storage device for supporting a portable computing system and a portable computing based system using the same, which substantially obviate one or more problems due to limitations and disadvantages of the related art.

It is an object of the present invention to provide a portable computing system that can operate anywhere with an OS-installed host computer by providing a portable storage device in a computing system and a portable computing based system using the portable computing system.

It is another object of the present invention to provide a more personalized portable computing system that can independently operate in an OS-installed host computing environment without installing and setting portable software stored in a portable storage device.

### Technical Solution

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a portable storage device for supporting a portable computing system including: a portable computing system storage storing portable software for running and operating of a portable computing system, wherein a user may not directly access the portable software for deletion and modification; a portable software storage storing portable software images usable in the portable computing system, wherein a user may not directly access the portable software images for deletion and modification; and a portable data storage capable of adding, deleting, and modifying data.

In another aspect of the present invention, there is provided a portable computing based system using a portable storage device for supporting a portable computing system, transmitting and receiving data when a host computer with an OS is connected to the portable storage device. The portable storage includes: a portable computing system storage storing portable software for running and operating of a portable computing system, wherein a user may not directly access the portable software for deletion and modification; a portable software storage storing portable software images usable in the portable computing system, wherein a user may not directly access the portable software images for deletion and modification; and a portable data storage capable of adding, deleting, and modifying data.

It is to be understood that both the foregoing general description and the following detailed description of the present invention are exemplary and explanatory and are intended to provide further explanation of the invention as claimed.

### Advantageous Effects

As illustrated above, according to the present invention, provided are the portable storage device for supporting a portable computing system and a portable computing based system using the same. The present invention employs the simple portable storage device with a more advanced computing system, operates anywhere through a portable software image in the computing system, and also more easily distributes and manages application programs.

Additionally, the portable computing environment of the present invention does not require host system booting, and does not store application programs that operate in a guest OS of an OS image but stores the application programs in a predetermined area of a portable storage device, with an application program package format. Such that installation and management of the application program can be easily done.

### BRIEF DESCRIPTION OF THE DRAWINGS

The accompanying drawings, which are included to provide a further understanding of the invention, are incorporated in and constitute a part of this application, illustrate embodiments of the invention and together with the description serve to explain the principle of the invention. In the drawings:

FIG. 1 illustrates an entire system for a portable computing system according to an embodiment of the present invention;

FIG. 2 illustrates a portable storage device 102 for a portable computing system according to an embodiment of the present invention;

FIG. 3 illustrates a block diagram of portable computing system storage 201 for running a host OS of a portable computing system according to an embodiment of the present invention;

FIG. 4 illustrates a block diagram of a portable computing system storage 201 for running a guest OS of a portable computing system according to an embodiment of the present invention; and

FIG. 5 illustrates a portable software storage 202 according to an embodiment of the present invention.

### BEST MODE FOR CARRYING OUT THE INVENTION

Reference will now be made in detail to the preferred embodiments of the present invention, examples of which are illustrated in the accompanying drawings.

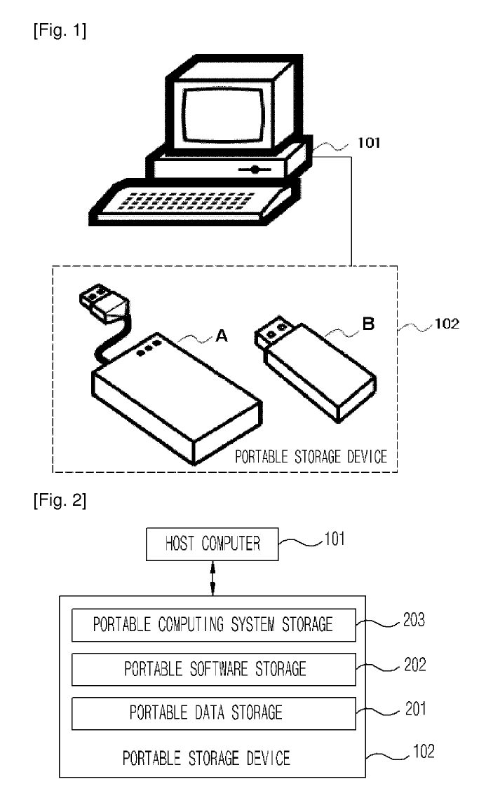

FIG. 1 illustrates an entire system for a portable computing based system according to an embodiment of the present invention. The portable computing based system includes a host computer 101 with an operating system (OS) and a portable storage device 102 with a portable computing system.

The portable computing based system (i.e., a computing system operating in the portable computing based system) is a system transmitting and receiving data when the host computer 101 is connected to the portable storage device 102.

The host computer 101 with an OS provides physical computing resources to operate the portable computing system such as a CPU, a memory, a storage space, a network, etc.

The portable storage device 102 for supporting the portable computing system includes a portable data storage (i.e., a basic storage space), a portable computing system storage, and a portable software storage, which are storage spaces with software resources such as a virtual machine supporting the portable computing system, an OS image, a portable software image, etc.).

The portable storage device 102, as illustrated in FIG. 1, may have various forms such as a form A in which an USB connector is connected to a cable and a form B in which an USB connector is fixed.

FIG. 2 illustrates a portable storage device 102 for a portable computing system according to an embodiment of the present invention. The portable storage device 102, which supports the portable computing system while being connected to the host computer 101, is largely divided into three storage spaces.

First, a portable computing system storage 201 stores core components for running and operating a portable computing environment, and a user may not directly access the portable computing system storage 201 for deleting and modifying corresponding software. The portable computing system storage 201 includes various tools in addition to a virtual machine and an OS image. They can be modified using a corresponding tool.

Second, a portable software storage 202 stores portable software images usable in the portable computing environment, and a user may not directly access the portable software storage 202 for deleting and modifying corresponding portable software images.

The portable software image includes information for installation and setting of software and an image of software files. Its format is executable without additional installation and setting. Accordingly, the portable software image is used for easy installation and distribution of software in the portable computing system.

Third, a portable data storage 203 can be accessed by a user and arbitrary data can be added, deleted, and modified therein like storage space of a general portable storage device.

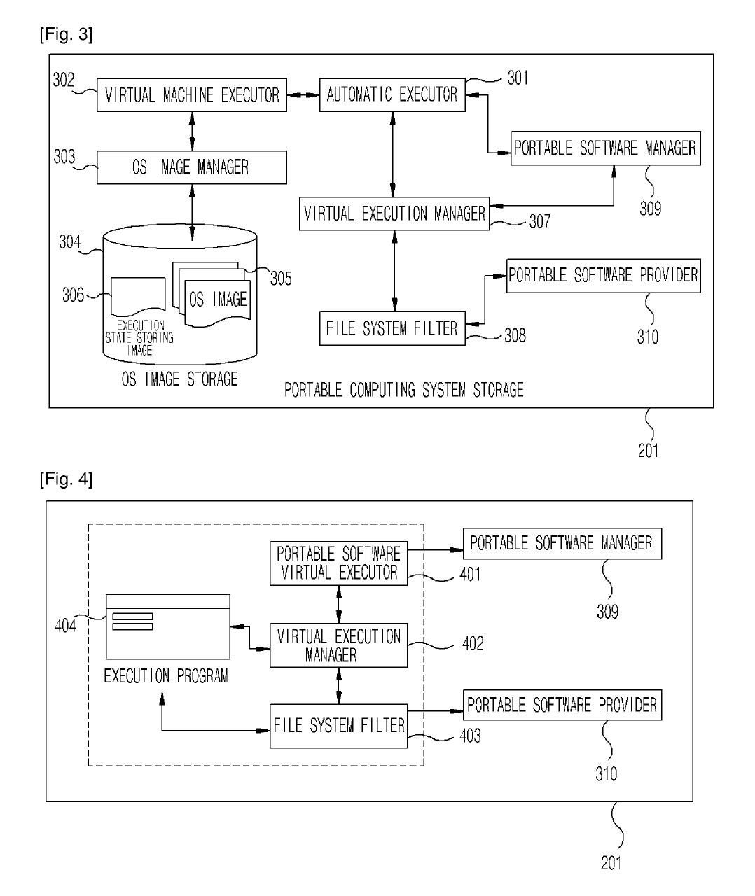

The components of the portable computing system storage 201 are divided into two types according to whether they operate in a host OS or in a guest OS. This will be described with reference to FIGS. 3 and 4.

FIG. 3 illustrates a block diagram of portable computing system storage 201 for running a host OS of a portable computing system according to an embodiment of the present invention.

Primarily, when the portable storage device 102 is connected to the host computer 101, the host computer 101 recognizes the portable storage device 102 and then, an automatic executor 301 of the portable storage device 102 automatically runs.

The automatic executor 301 displays a list of OS images bootable as a guest OS and a list of application programs executable in the host computer 101 directly.

The automatic executor 301 requests the list of application programs to a portable software manager 309, and the portable software manager 309 creates the list of application programs operable in a corresponding host computer environment, and sends the list to the automatic executor 301. That is, the automatic executor 301 displays the list of application programs, which is delivered from the portable software manager 309.

When a user selects an OS image fit for the guest OS among the list of OS images bootable as the guest OS and the list of application programs executable in the host computer 101 directly, which are displayed in the automatic executor 301, a virtual machine executor 302 requests information for an OS image fit for the selected guest OS to an OS image manager 303.

On the other hand, the virtual machine executor 302 includes a plurality of virtual machine executable files for supporting various host computers, and the virtual machine executable files operable in the host computer 101 are automatically selected.

The OS image manager 303 requests necessary parameter information to the OS image storage 304 when the OS image fit for the selected guest OS operates in a virtual machine, and then delivers the requested result to the virtual machine executor 302 to boot the corresponding guest OS.

If there is the execution state storing image that is stored in the OS image storage 304 during the previous operation, the result image is also delivered into the virtual machine executor 302 to restore the previous operation state.

Here, an OS image 305 of the OS image storage 304 is a file that compresses an OS such as Linux and Window in a specific format, and the execution state storing image 306 allows a user to more easily restore the previous operation state by using a compressed and stored file for continuous operations.

On the other hand, if a user does not select the OS image fit for the guest OS in the automatic executor 301 and selects executable application programs in the host computer 101, a virtual execution manager 307 starts and requests necessary environment information for running the corresponding application program to the portable software manager 309, and creates a virtual environment as if the application program is installed in the host computer 101.

Once the corresponding application program runs, a file system filter 308 requests necessary file blocks to the portable software provider 310 each time file I/O occurs in a file system, and then read the requested file blocks from the portable software provider 310 and loads it into a memory, such that the application program starts.

If a user selects the OS image fit for the guest OS, the application program starts as illustrated in FIG. 4.

FIG. 4 illustrates a block diagram of a portable computing system storage 201 for running a guest OS of a portable computing system according to an embodiment of the present invention.

Application program execution operations of the guest OS is similar to those of when a user selects application programs, which are executable in the host computer 101, from the automatic executor 301. To execute the application programs in the guest OS, a portable software virtual executor 401, a virtual execution manager 402, and a file system filter 403 are should be included when creating the OS image.

As illustrated in FIG. 3, if the OS image fit for the guest OS, which is provided from the automatic executor 301, is selected, a user can see an application program list usable in the guest OS by the portable software virtual executor 401.

This application program list can be obtained when the portable software virtual executor 401 requests it to the portable software manager 309. That is, the portable software manager 309 creates the list of application program list operable in the corresponding guest OS environment, and delivers it to the portable software virtual executor 401.

If a user selects the application program, the virtual execution manager 402 is executed and requests necessary environmental information for running a corresponding program to the portable software manager 309 in order to create a virtual environment as if the application program is installed into the guest OS.

When running the corresponding application program, the file system filter 403 requests and reads necessary file blocks to and from the portable software provider 310 each time a file I/O occurs in the file system, and loads it into the memory, such that application program can start.

That is, according to the present invention, the application program is not installed into the host computer, but operates as if it is by using the virtual environment.

FIG. 4 illustrates a block diagram of a portable computing system storage 201 for running a guest OS of a portable computing system according to an embodiment of the present invention. A file system filter 403 intercepts an I/O file generated by the OS and converts it into an I/O of the portable storage device 102, and also displays the portable data storage 203 to a user as a file system that an executed application program can primarily access.

For example, after a user starts a word processor program for editing a document through the virtual software executor and saves it as a file, the edited document can be firstly saved in the portable data storage space through the file system filter.

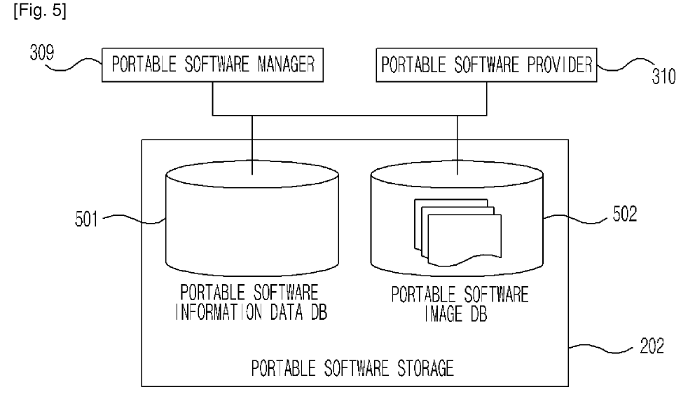

FIG. 5 illustrates a portable software storage 202 according to an embodiment of the present invention. The portable software storage 202 stores portable software information data 01 and a plurality of portable software images 502.

The portable software images 502 are stored in a specific file format that can be recognizable by tools of the portable computing system storage 201.

The portable software information data 501 are installation and setting information of the portable software image 502, and the portable software image 502 includes file images constituting software.

It will be apparent to those skilled in the art that various modifications and variations can be made in the present invention. Thus, it is intended that the present invention covers the modifications and variations of this invention provided they come within the scope of the appended claims and their equivalents.

1. A portable storage device for supporting a portable computing system, comprising:
a portable computing system storage storing portable software for running and operating of a portable computing system, wherein a user may not directly access the portable software for deletion and modification;
a portable software storage storing portable software images usable in the portable computing system, wherein a user may not directly access the portable software images for deletion and modification; and
a portable data storage capable of adding, deleting, and modifying data.

2. The device of claim 1, wherein the portable computing system storage comprises an automatic executor that automatically displays an operating system (OS) image list, which is bootable as a guest OS, and a portable software list, which is directly executable in a host computer, in a screen of the host computer while the portable storage device is connected to the host computer.

3. The device of claim 2, wherein the portable computing system storage comprises:
a virtual execution manager requesting environmental information for executing portable software executable in the host computer to create a virtual environment;
a portable software manager providing the environmental information to the virtual execution manager after the virtual execution manager requests the environmental information for executing the portable software to the portable software manager;
a file system filter requesting necessary file blocks when a file I/O in a file system while executing the portable software executable in the host computer, and then loading them into a memory to execute the portable software; and
a portable software provider storing necessary environmental information for executing portable software and portable software images, and providing the necessary file blocks when the file I/O occurs to the file system filter,
wherein when the portable software, which is provided from the automatic executor and is directly executable in the host computer, is selected, the portable computing system storage supports direct execution of the portable software in the host computer.

4. The device of claim 3, wherein the portable software manager adds and deletes the portable software image.

5. The device of claim 3, wherein the portable computing system further comprises:
a virtual machine executor requesting information for an OS image fit for the selected guest OS to an OS image manager, and automatically selecting and executing a virtual machine execution file operable in the host computer;
the OS image manager delivering the requested result related to a position of the OS image and necessary parameter information while executing the OS image and an execution state storing image to the virtual machine executor; and
an OS image storage storing an OS image compressing an OS into a specific file format and an execution state storing image compressing the previous operation state into a file for continuous operations,
wherein the portable computing system storage supports execution of the guest OS when an OS image, which is provided from the automatic executor and bootable in the guest OS, is selected.

6. The device of claim 5, wherein the OS image bootable in the guest OS comprises:
a portable software virtual executor requesting a list of portable software usable in the guest OS to the portable software manager according to a user's request;
a virtual execution manager requesting necessary environmental information for executing of portable software selected from the provided list of portable software to the portable software manager to create a virtual environment; and
a file system filter requesting necessary file blocks when a file I/O occurs in a file system and loading them into a memory to operate the portable software.

7. The device of claim 6, wherein the portable software manager creates a list of portable software operable in the guest OS and delivers it to the portable software virtual executor.

8. The device of claim 6, wherein the file system filter converts I/O occurred in the file system into I/O of the portable storage device.

9. The device of claim 6, wherein the file system filter allows the portable software executable in the guest OS to be shown as a primarily accessible file system.

10. The device of claim 1, wherein the portable software storage comprises:
a portable software information storage storing portable software information; and
a portable software image storage storing portable software images.

11. The device of claim 10, wherein the portable software image comprises information for installation and setting of portable software and an image of portable software files.

12. A portable computing based system using a portable storage device for supporting a portable computing system, transmitting and receiving data when a host computer with an OS is connected to the portable storage device,
wherein the portable storage comprises:
a portable computing system storage storing portable software for running and operating of a portable computing system, wherein a user may not directly access the portable software for deletion and modification;
a portable software storage storing portable software images usable in the portable computing system, wherein a user may not directly access the portable software images for deletion and modification; and
a portable data storage capable of adding, deleting, and modifying data.
